(19) United States
(12) Patent Application Publication
(10) Pub. No.: US 2014/0097280 A1
(43) Pub. Date: Apr. 10, 2014

(54) Garbage container for collection of solid waste

(71) Applicant: Jesus Perez Santafe, ZARAGOZA (ES)

(72) Inventor: Jesus Perez Santafe, ZARAGOZA (ES)

(21) Appl. No.: 14/037,508

(22) Filed: Sep. 26, 2013

Related U.S. Application Data
(63) Continuation-in-part of application No. 12/597,775, filed on Mar. 26, 2010.

(30) Foreign Application Priority Data
Apr. 27, 2007 (ES) P200701259

(51) Int. Cl. B02C 18/16

(52) U.S. Cl. CPC B02C 18/16
USPC 241/101.3; 241/236

(57) ABSTRACT

An apparatus for grinding solid waste, the apparatus comprising: a first plurality of grinding blades parallel to one another and disposed on a first axle perpendicular to an axis thereof; a second plurality of grinding blades parallel to one another and disposed on a second axle perpendicular to an axis thereof, the axis of the second axle being parallel to the axis of the first axle, wherein the first and second plurality of blades are interleaved and adapted for counter-rotation with respect to each other; a set of gears operatively connected to each of the first and second axles; and means for driving the set of gears to effectuate rotation of each set of grinding blades.

### FIELD OF THE INVENTION

The present invention relates to waste collection. Specifically, the present invention concerns a garbage container for collection of solid waste.

### BACKGROUND OF THE INVENTION

Evidence most representative prior technical and the most relevant is the GB patent 2407282 of Damani et al. published on Apr. 27, 2005. A problem with the waste container described in this document is that a motor is used to power a device that crushes the wastes. The waste container is therefore relatively complex and expensive.

In view of the above, there is a need in the industry to provide novel and improved hoist overload protectors.

### SUMMARY OF THE INVENTION

In a broad aspect, the invention provides an apparatus for grinding solid waste, the apparatus comprising: a first plurality of grinding blades parallel to one another and disposed on a first axle perpendicular to an axis thereof; a second plurality of grinding blades parallel to one another and disposed on a second axle perpendicular to an axis thereof, the axis of the second axle being parallel to the axis of the first axle, wherein the first and second plurality of blades are interleaved and adapted for counter-rotation with respect to each other; a set of gears operatively connected to each of the first and second axles; and means for driving the set of gears to effectuate rotation of each set of grinding blades.

In a variant, the set of gears comprises at least one of the group: epicyclical, cycloidal, and planetary.

In a variant, the means for driving the set of gears is chosen from the group: manual, hand-operated, foot operated, and electric.

In a variant, the set of gears is chain driven.

In a variant, the axles and the blades are spring loaded.

In a variant, the apparatus further includes means for preventing retrograde movement of the plurality of blades, the means for preventing retrograde movement comprising a ratcheting system.

In a variant, the apparatus further includes means for separating the first and second axles to prevent jamming, wherein the means for separating the first and second axles to prevent jamming comprises an axle backlash tolerance.

In a variant, the grinding blades pivot.

In a variant, the grinding blades are released when a tough piece of waste is encountered.

In a variant, the apparatus further includes means for cleaning the grinding blades

In a variant, the apparatus further includes a scale for weighing the ground waste material.

In a variant, the apparatus further includes a global positioning system (GPS) for signaling location of the ground waste material.

In another broad aspect, the invention provides a crushing container for solid waste collection, the crushing container defining container left and right sides, the crushing container comprising: a container body, the container body defining an upper aperture leading thereinto; at least two crushing elements each supported in the container body and each rotatable on a respective crushing element axis extending generally parallel to the upper aperture, each of the crushing elements including a plurality of blades extending generally substantially perpendicular to the crushing element axis, the blades of one of the crushing elements being interleaved with the blades of the other one of the crushing elements, the crushing elements being operatively coupled to each other so as to be jointly counter-rotatable with respect to each other; a sliding lid provided substantially adjacent the upper aperture, the sliding lid being movable along the container so as to be positionable in a lid closed position, wherein the lid is substantially in register with the upper aperture and a lid open position wherein the lid is at least partially retracted from the lid upper aperture, the sliding lid being operatively coupled to the toothed crushing elements for rotating the crushing elements when the sliding lid is moved between the lid open and closed position.

The current system of selective collection of solid waste in Europe is based on the location on the street of similar waste containers only different by color or shape. The present system innovates because it introduces a volume reducing system that can reduce, for example, waste five and up to ten times the volume of the actual waste collection systems because the container introduces a toothed wheel system driven by a series of sprockets when turning are driven by toothed drums activated by manual movement of the sliding top lid of the container, ensuring its grinding through a slitter blade system—or even small hammers for glass—, system that may be implemented in public administrations to require waste collection services, so that the collection is “nonmaterial” (—from a unique material—) due to the introduction of different specialized container for each type of waste so that it can be required due to the existence of the following types of containers:
A specific plastic type containers HDPE, FELD, PS, PP and PET (—For example in yellow—);
Another type for metal can collecting (for example gray);
Other for the cartons collecting (—for example silver—);
Another type of container for paper and cardboard (—for example, blue—);
One for glass collection (for example: light green—);
One for organic waste collection (—for example, brown—),
And one for the collection of non-recyclable waste (—for example dark green—)

It is possible to increase the range of containers to other specialized that can be

used in public spaces for a collection of more specialized use such as the collecting of:—batteries, appliances, furniture, wood and other bulky waste even tissues or other potentially polluting domestic waste such as used oil, or non-biodegradable chemicals such as cleaners, detergents, varnishes, paints, medicines, among others.

This invention belongs to the technical field of grinding which seeks to contribute to current waste recycling systems adding a mechanical grinding in the already existing waste containers reducing volume of different types of solid waste from human daily consumption, avoiding the use of more natural resources and irresponsible and abusive consumption of raw materials every day less abundant. In a specific embodiment of the invention, its system is based on a simple manual mechanism consisting of a group of toothed wheels that achieves by transforming a simple movement of moving the sliding upper lid opening the container, in a rotary motion of the blade axes minimizing the volume of different types of waste—either cans, packaging paper, paper, organic matter, glass (vitreous vessels), non-recyclable waste, according to different blade systems, adapted to each type of waste (in case of glass are replaced by a disk system with small hammers) being enough with the will to move, helped by a pedal on which to transfer our body weight or to give more force reducing these blades (—pedal that is essential in case of metal containers because of its hardness).

The present invention in its manual version, unlike its motorized variant, is completely ecological in its use because it does not consume any type of energy for its use, trying to cooperate with various European Public Services (Regional and Local Administrations) in accomplishment with Directive 2004/12/CE it imposing on Member States of the European Union the obligation to take measures to reach-in phase 2 these objectives:

D) On Dec. 31, 2008 at latest, a minimum of 55% and a maximum of 80% weight of waste containers must be recycled.

E) On 31 Dec. 2008 latest the following minimum recycling targets for materials measured in the waste containers must be achieved:

I) 60% weight of glass.
Ii) 60% weight of paper and cardboard.
Iii) 50% weight of metals.
Iv) 22.5% weight of the plastics material counting only the one that is recycled back into plastic, and
v) 15% weight for wood.

Other objects, advantages and features of the present invention will become more apparent upon reading of the following non restrictive description of preferred embodiments thereof, given by way of example only with reference to the accompanying drawings.

### BRIEF DESCRIPTION OF THE DRAWINGS

In the appended drawings, the following Figures illustrate:

FIG. 1.1: Front view of the closed container.

FIG. 1.2: Side view of the closed container.

FIG. 2.1: Side view of the outside of the container.

FIG. 2.2: Side view from the inside the container from its right.

FIG. 2.3: Inside view from the right side of the container with the lid is open incorporating the position of the frame.

FIG. 3.1: Side drums common base showing the zones guides crossing the four axes of blades before the opening of the sliding lid.

FIG. 3.2: Base of side drums indicating zone guides crossing the four blades axes after the opening of the sliding lid.

FIG. 4.1: Left drum view from the inside with top sliding cover closed.

FIG. 4.2: Left drum seen from the inside, with the top sliding lid open to its limit.

FIG. 5.1: Right drum viewed from the outside with top sliding cover closed before moving, indicating the position of the chain axis.

FIG. 5.2: Right drum viewed from the outside, with the top sliding lid open to its limit.

FIG. 6: Drums support frame and blade axes.

FIG. 7.1: Inside view of the container showing the common basis of the two drums and the position of blade axes.

FIG. 7.2: Front view of the inside of the container reflecting the profile of the drums and transverse position of the blade axes.

FIG. 7.3: Side view of the frame showing the position of the top axes E-1 and E-3 and of the lower shafts E-2 and E-4, its bearings and smaller wheels R-5 and R-6.

FIG. 8.1: Top view of the frame indicating the position of the four sets of blades and two drive pulleys on the sides of the frame.

FIG. 8.2: Rotation of 90 degrees from the vertical position of the container shown in FIG. 8.4.

FIG. 8.3: Top view of the container indicating the position of anchoring the rack and the drum shafts on the sides of the frame.

FIG. 8.4: Rotation of 90 degrees position of the container shown in FIG. 8.3.

FIG. 9.1: Blade in normal position.

FIG. 9.2: Blade in awkward position.

FIG. 9.3.1: Top of the box spring.

FIG. 9.3.2: Initial position of the blades to axis through the lever drag.

FIG. 9.4.1: Box spring in the normal position without its lid.

FIG. 9.4.2: Blade spring box after closure.

FIG. 10.1: Blade normal position (vertical).

FIG. 10.2: Angled blade—left at the top.

FIG. 10.3: Blade at an angle—right on top.

FIG. 10.4: Blade in normal position providing limits of its spin.

FIG. 10.5: Blade in vertical position incorporating spring in its normal position.

FIG. 10.6: Angled left blade—incorporating springs supporting its left pressure.

FIG. 10.7: Angled right blade—incorporating springs supporting its right pressure.

FIG. 11.1: Angled movement of the blade in different positions at different pressures.

FIG. 11.2: Different positions of the internal lever blade at different blade positions and different pressures.

FIG. 12.1: Lever in central position.

FIG. 12.2: Left Lever position (angled—left).

FIG. 12.3: Right lever position (angled—right).

FIG. 13.1: Side view of the container showing blade positions.

FIG. 13.2: View of the blade axes, viewed from the side drums.

FIG. 13.3: Distribution detail of the blade axes on the side of the frame.

FIG. 13.4: Side view of the blades for tin cans or other metal containers (—Top blades six teeth or claws and bottom blades with 4 teeth or nails placed in their lobes—).

FIG. 14: Different blades for plastic containers.

FIG. 15: Different blades for cartons containers.

FIG. 16: Different blades for paper and cardboard.

FIG. 17: Different blades for organic matter.

FIG. 18: Small hammer blades for glass and other vitreous materials.

FIG. 19: Blades for non-recyclable waste (—useless—).

FIG. 20: Opening of frame (three phases) to allow exit of waste from the container.

FIG. 21.1: Position allowance devices.

FIG. 21.2: Position of these devices, seen from the top.

FIG. 21.3: Position of the devices seen from a vertical and lateral position.

FIG. 21.4: Raised view of these devices.

FIG. 21.5: More detailed view of a device (—spring of tolerance).

FIG. 21.6: Position of axis E-3 and E-4.

FIG. 21.7: Forced position of the axis.

FIG. 22.1: Side view of the manual domestic container, seen from the outside.

FIG. 22.2: Side view of the manual domestic container, seen from the inside.

FIG. 22.3: Top view of the manual domestic container.

FIG. 22.4: Front view of the domestic container.

FIG. 23.1: Top view of the frame indicating the position the 4 blade axes and two drive pulleys operated by side motors.

FIG. 23.2: 90 degrees rotation from position shown in FIG. 23.4.

FIG. 23.3: Raised front view position of the container and the position of the anchoring frame.

FIG. 23.4: 90 degrees rotation of the container shown in FIG. 23.3.

FIG. 24.1: Side view of domestic garbage container, in its motorized version, seen form the outside.

FIG. 24.2: Side view of domestic garbage container, in its motorized version, seen form the inside.

FIG. 24.3: Top view of domestic garbage container, in its motorized version.

FIG. 24.4: Front view of domestic motorized garbage.

FIG. 25: Front view of domestic garbage container, in its mixed version, both manual and motorized.

### DETAILED DESCRIPTION

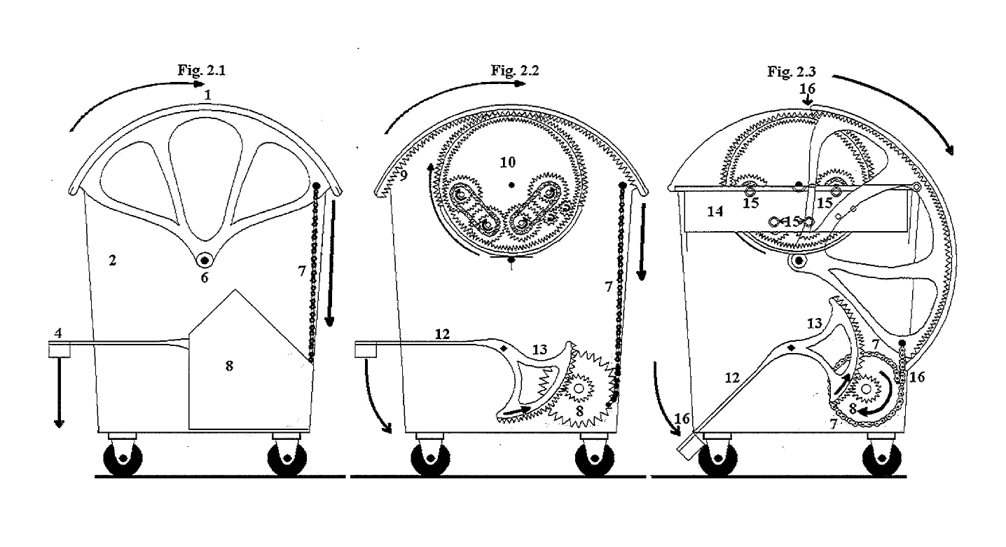

Introducing the explanation of the invention, the first phase of mechanical grinding system is based on the transformation of a mechanical movement produced by a horizontal displacement of the curved sliding lid (1)—located on the upper side of the container, transforming the opening movement (16) in a circular motion of the two drums (10) of gears located on the side walls of the container (both left and right) by a symmetrical teeth system, acting as a “zipper”, causes the rotation of each drum as an eyelid (curved top) rotating on its eye (or drum), situated on the upper side of each drum of the container. The movement of the sliding lid on its own rotation axis (6), makes its own toothed bands (9) located at the bottom both left and right sides of the cover move the teeth of the outer zone (9) of each drum which is supported on an independent frame (14) thereby causing the circular motion of the side drum—as explained in FIGS. 2.1, F. 2.2 and F.2.3.

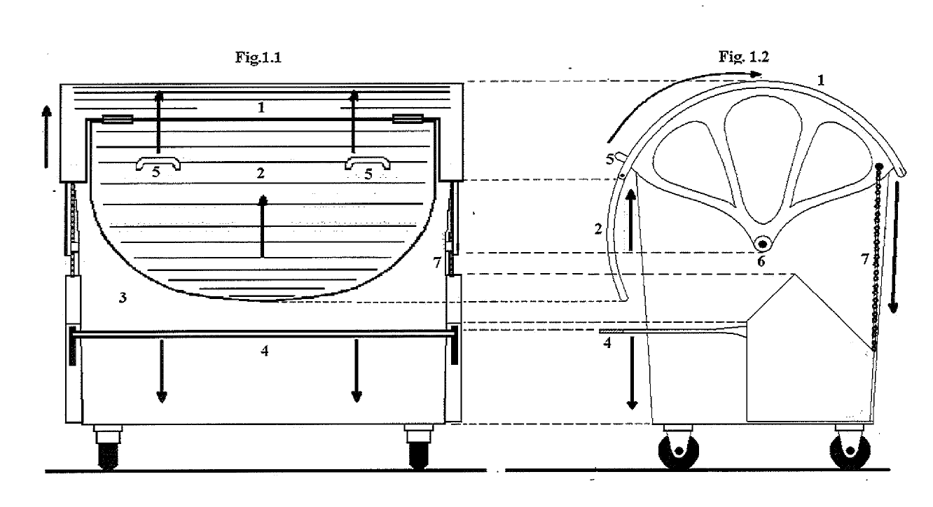

In the same way, and in order to ensure the opening of a sliding lid with hands (5) it is provided with a horizontal bar (4) in the bottom front face of the container (as shown in FIG. 1) that, in order to give more strength to the opening the top lid, transmitting a descendant movement of the horizontal bar, in a downward angular movement of each of the side levers (12) located on both left and right sides of the container, so that the movement of the toothed roller (13), located at the end of each lever, will produce the turning of a smaller sprocket embedded in a concentric way on other larger sprocket located at the bottom (8) on each side of the container, this rotation causing the chain winding around each of the larger sprocket located on each side, which are attached directly to the rear corners of the left and right sides of the said sliding lid explained in FIG. 2.2 and FIG. 2.3—, in order to assist the sliding of the opening, by the downward traction function realized by the rolling of the chain on the sprockets located at the bottom of the container.

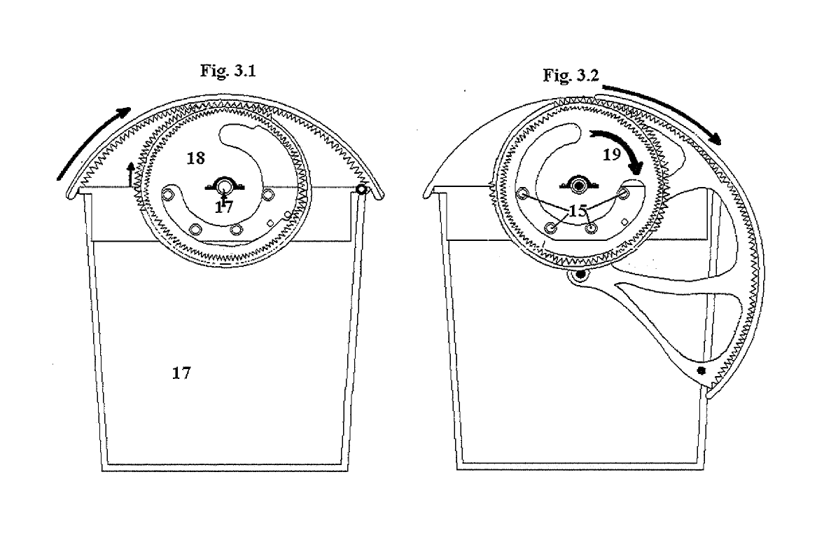

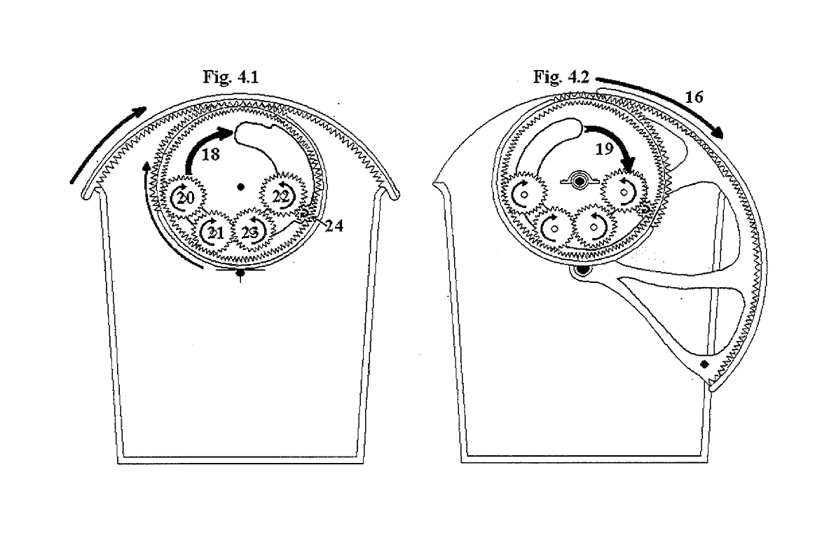

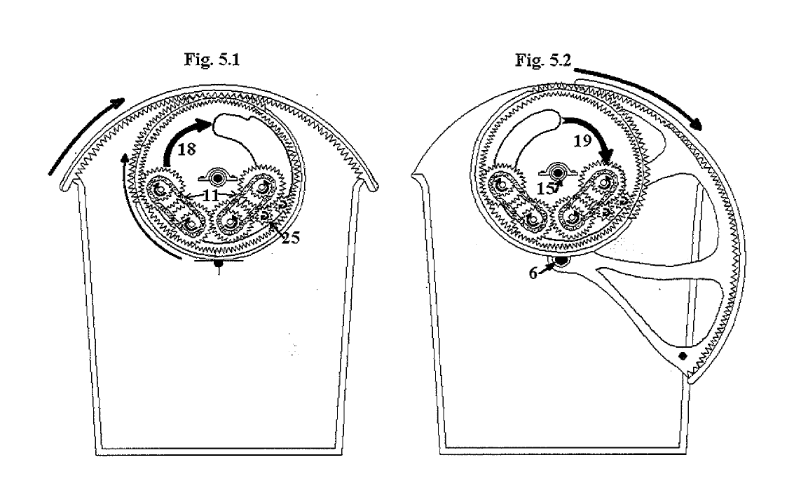

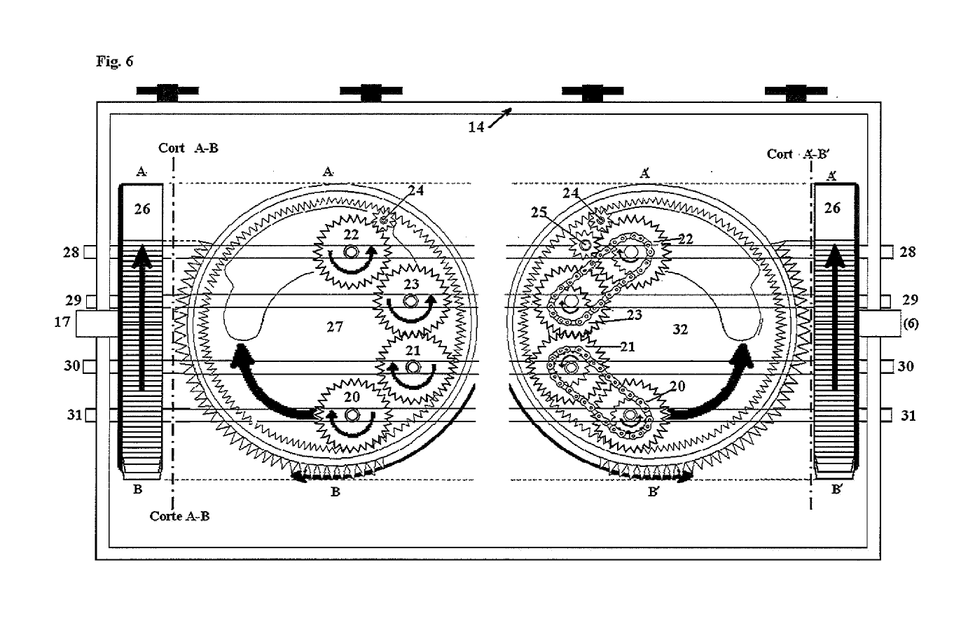

In a second mechanical phase, simultaneous in time, the movement caused by the upper sliding lid over each of the two drums located on the upper side of the side walls both left and right sides of the container, gives them a circular motion to each of the two side drums respect their axes (as shown in FIG. 3.1 and FIG. 3.2)—, this movement of the drums rotates the sprockets (—20, 21, 22, 23, 24 and 25 —) located inside of each drum—as shown explicitly in FIG. 4.1 and FIG. 4.2 relative to the drum left in FIG. 5.1 and right in FIG. 5.2 supported by their respective axes, are embedded in a rectangular frame through each pawl bearings (38), as shown in FIG. 6—.

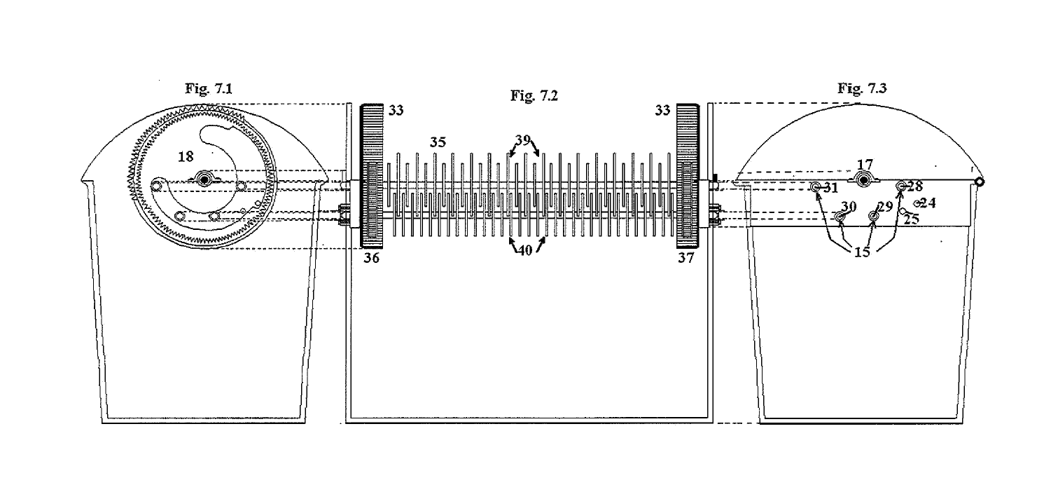

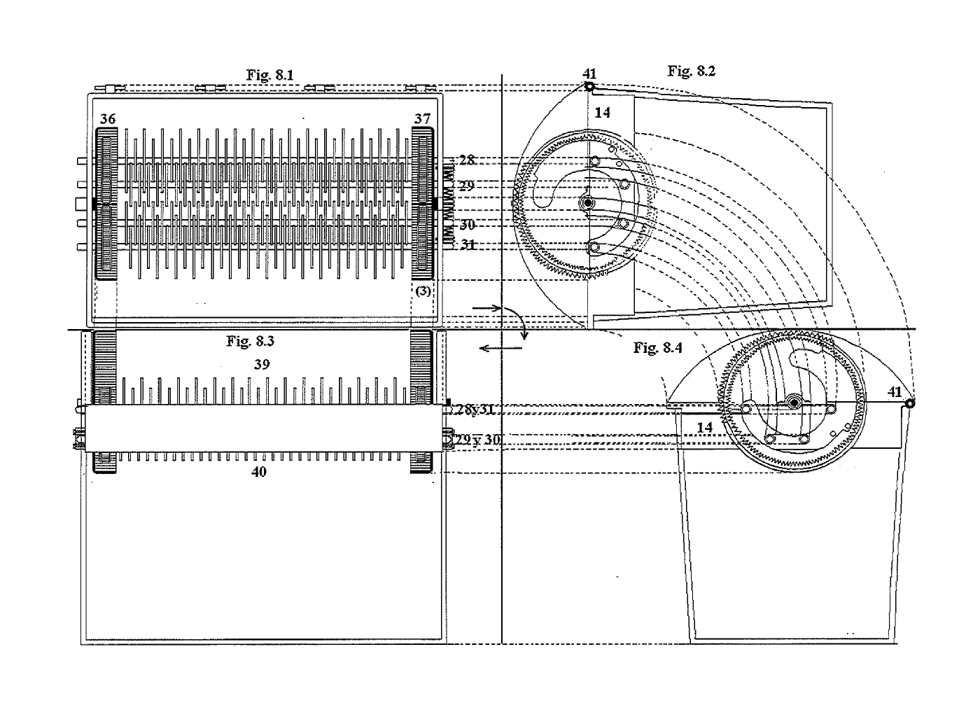

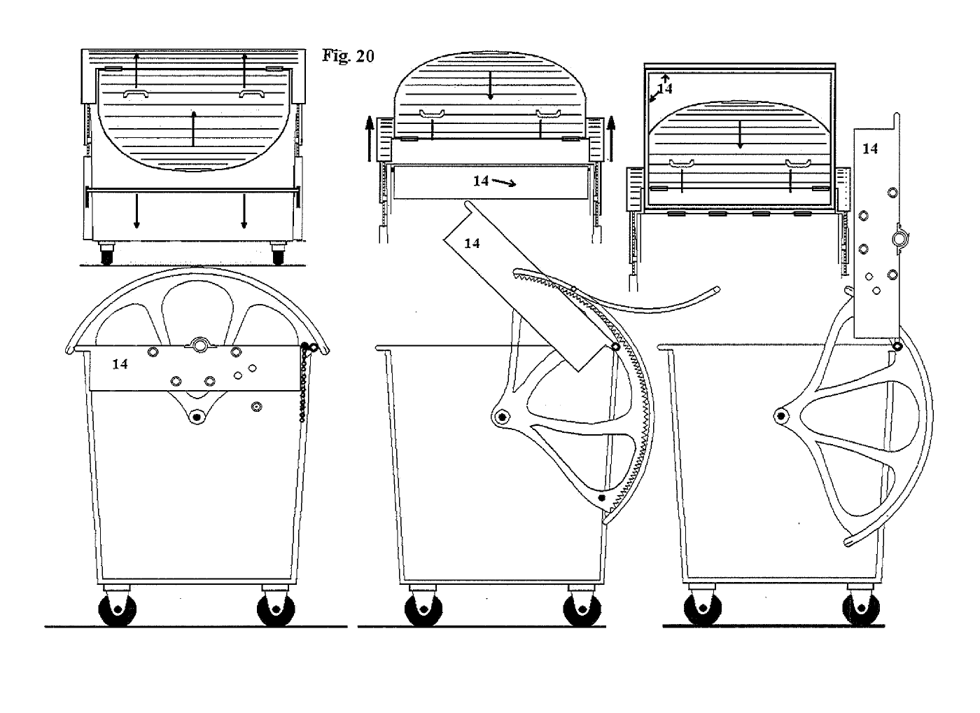

On the other hand, this frame (14)—which is situated at the upper and interior of the container as an internal belt and must be constructed of a robust material to support the torsions generate the blade axes (—28, 29, 30 and 31 —) which hold, (—which in the example shown in FIG. 2 et seq is configured with four blade axes, although the number of axes may be higher or lower depending on requirements), the rack in which its axes (—activated by its respective smaller gear wheels at the ends of each axis) will be moved by the action of the said side drums (as explained in FIG. 6), thanks to these small sprocket of the blade axis are located inside the side drum and should consider that these axes are supported on both sides of the frame thanks to its own pawl bearings (15) situated equally on both side ends of each axis (as if seen in FIGS. 7 and 8), This frame is configured as an independent structure respect to the body of the container (3) in which it rests, and whose fastening to the bottom is ensured by several hinges (41) located on the upper side of the back wall of the container (FIG. 6, FIG. 7.3, FIG. 8 and FIG. 20 —) in order that such a frame can be swigged and empty waste introduced inside (—containers, cans, etc.) once this waste has been crushed by the action of the blades (39 and 40) placed perpendicular to the transverse axis, which moved by the two drums, are also embedded in the frame (FIGS. 8.1, 8.2, 8.3 and 8.4)

In this third phase, equally synchronized in time as the two before, —the movement of the two side drums caused by the lid, will cause the following rotations induced by each group of four small gears placed in contact with each other (—inside of each of the two side drums) such that:
On one hand, thanks to the four internal gears located on the left drum supporting the respective left ends of each of four blades and shafts,
Furthermore, thanks to each of the four internal sprockets located on the right drum, support the right blade axes, this arrangement of gears located on the inside of each drum will cause a simultaneous rotation of each drum, caused also by the action of the sliding lid-causing synchronous rotation of each of the smaller sprocket located inside each drum. Thereby causing the rotation of each of the blades axes of (—whose inner wheels for each drum R-1 R-2 R-3 and R-4 are drawn with teeth 30 each as an example—) rotating a 360-degree each of the four mentioned blade axes. Although such axes are actually supported by the frame, this frame constitutes the real support for the four blade axes of the two side drums, since they are embedded in the frame transversely respect its bearings (—see FIGS. 6, 7 and 8—) since such drums do not support the axles, they only make them move.

In the same phase we must inform you that the peculiar position of the four small gears introduced in the inside of each side drum (as indicated in FIG. 6) makes one hand, R-1 and R-2 sprockets—(drawn as an example with 30 teeth and inner drum drawn with 120 teeth)—rotate synchronously and in the same way with the movement of the sliding lid, causing the rotation of the two lateral drums on their respective axes on the frame, in the following ways:
The right drum clockwise (viewed from the outside the container), while producing the movement of the four gears inside each drum, with following effects: in the first place (see FIG. 6) left drum wheels R-1 20 and R-2 (21), will rotate clockwise (viewed from the inside of the container) causing internal sprockets R-3 (22) and R-4 (23), (—identical in construction to the wheels R-1 and R-2—) rotate counter clockwise (seen from the inside of the container) by the action of the rotational effect produced by the interposition of the small inner wheel R-5 (24) (—drawn in said FIG. 6 —) so that this interposition shifts the rotational movement, in a clockwise direction, causes the tread band located in the inner ring of the drum, producing in R-3 wheel an opposite movement—therefore, in counter-clockwise effect, in an identical turn which causes wheel R-2 to wheel R-4, since, because its teeth are contiguous the wheel R-2 causes to wheel R-4 an opposite movement, producing the same process inverted in the right drum.

Therefore, and in order to explain the rotation of the grinding axis, as the fourth effect of the movement of the lid, we clarify that in case of axis E-1 (31) and E-2 (30) its rotation will be:—in the left drum, in a clockwise sense if viewed from the inside the container, while:—in the right drum, on axis E-1 and E-2, will rotate in a counter clockwise sense if we look from inside of the container, for the case of axis E-3 (28) and E-4 (29) will be opposite to the direction axis of rotation of E-1 and E-2, in both drums, this will cause a synchronous and simultaneous movement in a opposite direction between the two axes. Both upper blades E-1 and E3 and between the two lower blade axis E-2 and E-4, because the first two blades have the function of bringing closer the waste dropped in the central area of the container for grinding, turning both axes above E-1 and E-3 in a contrary sense to each other, while initially pushing and flattening such waste, whereas the lower axis E-2 and E-4, turn out the function of swallowing the grinded, turning these axes opposite to each other, while crushing the waste when they come near the upper blade axes, once crushed to the bottom of the container.

Grinding system: Though the compression system of the crushing of waste by the intersection of blades on their axes is the same for all types of waste (with the exception of glass, which is performed by a system of small hammers) however the size of the disc blades (43) will change depending on the type of waste to be crushed, but in all cases, this new system is characterized in that the blades are not fixed, such as other electric grinders—in this case this blade to its axis is movable.

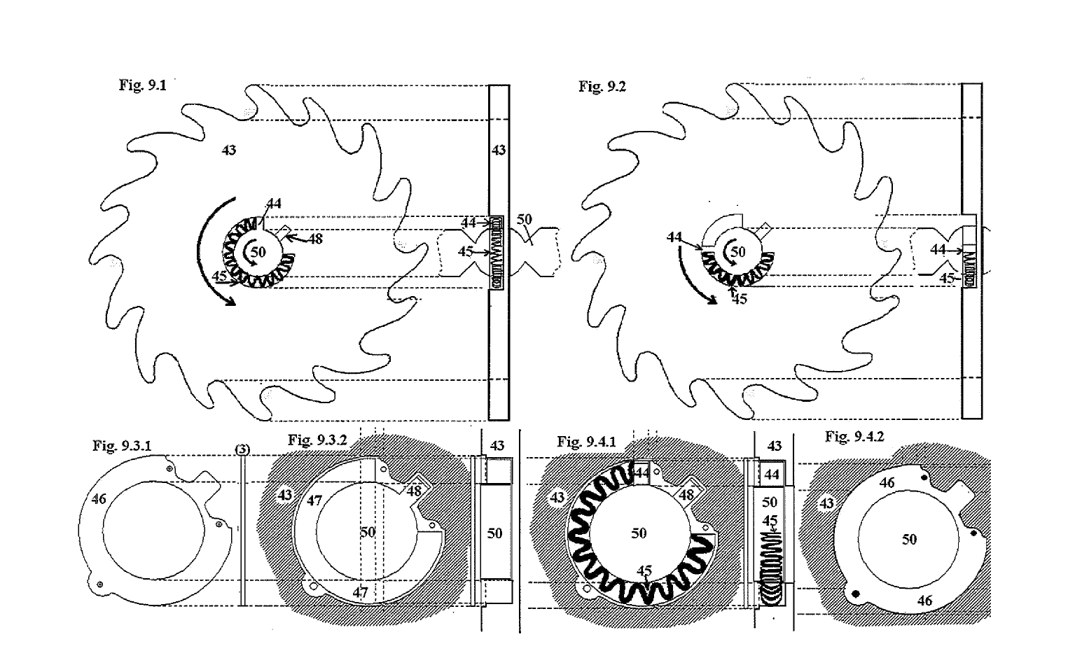

A) —In the first place it is mobile in its attachment, which allows the blade to stop or slow even if its axis continues turning, while its robust internal spring (45) (—in the attachment zone of blade axis (47)—) allows the blade to make the necessary tolerances that will require the grinding of harder materials that all waste incorporate, and although the spring is to give in gradually, such tolerance of the spring will end at a maximum recoil (located around the axis) whose internal shaft lever (44) will not continue to allow more braking (see FIGS. 9.1, 9.2, 9.3 and 9.4), causing the limit of tolerance a sharp stop to its blade, highly effective for the grinding of different types of waste, even considering, that for each type of waste we may incorporate a different type of spring, more or less strong and adjust this circular spring, —for example regulating the spring by screwing.

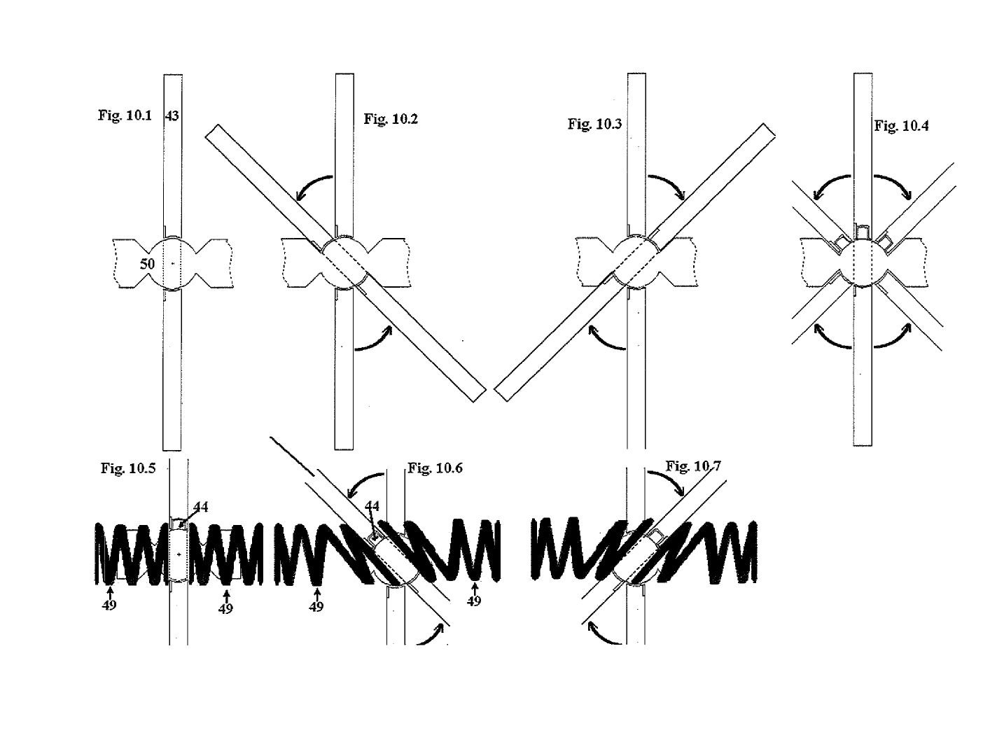

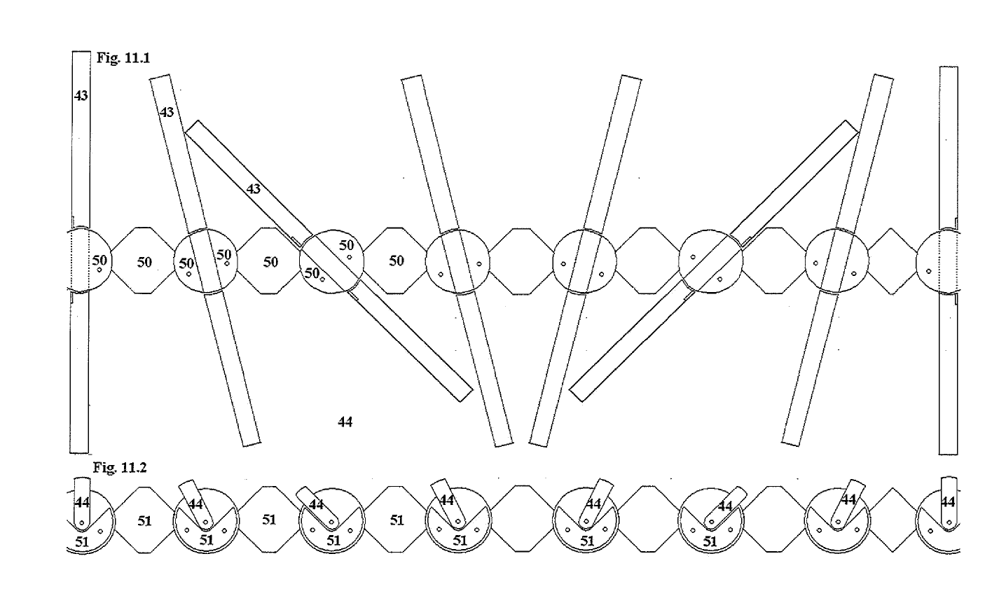

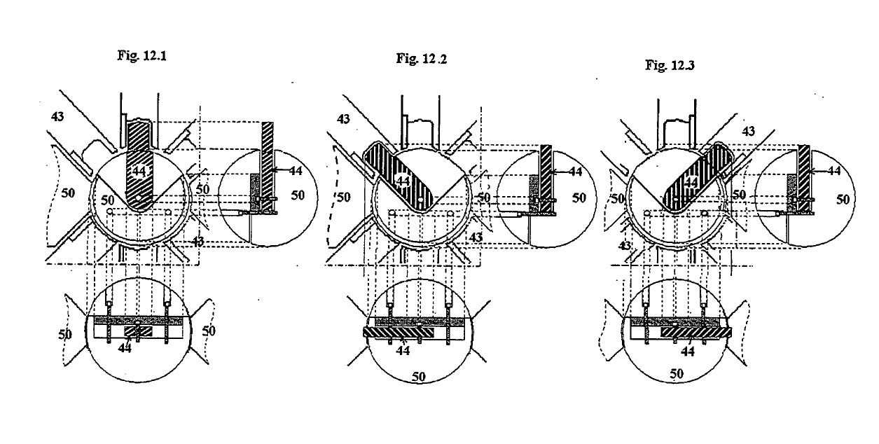

B)—Secondly, this blade system (39 and 40) with tolerance in rotation on its own axis (50 and 51), also has a secondary lock system that allows oblique side movement of the blade perpendicular to its axis which is located in the blade, leaving its initial parallel position with the other blades, this occasional oblique position will allow the entry of this crushable waste, waste with excessive hardness or volume, that would otherwise block the crusher axle (—FIGS. 10.1 to 10.7 and 12 —) thanks to the positioning of springs (49) between the blades axis, to recover blade to its initial vertical position.

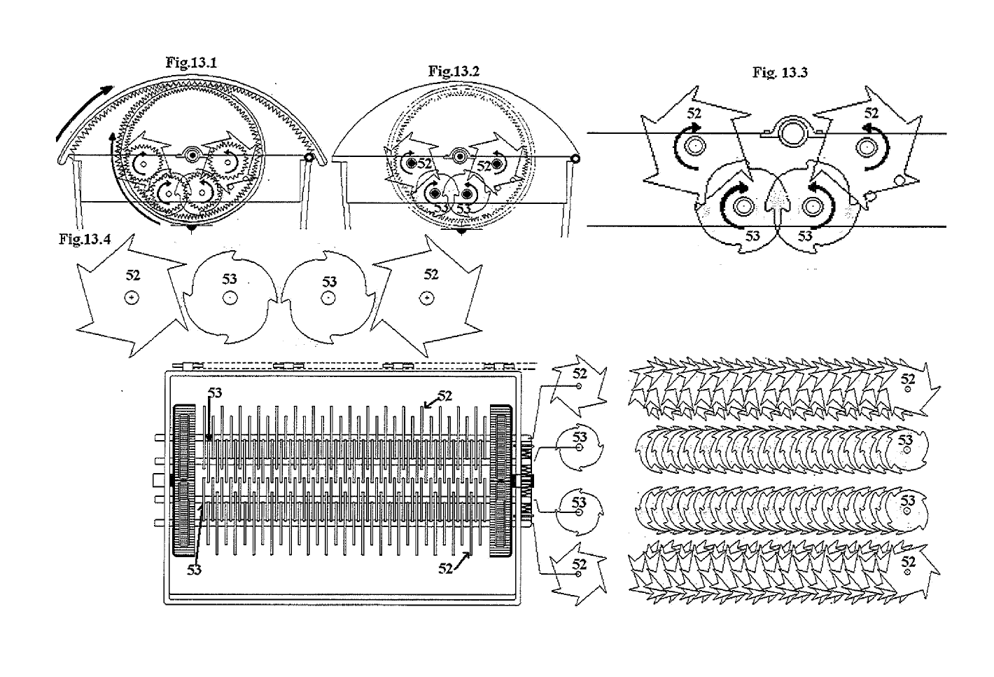

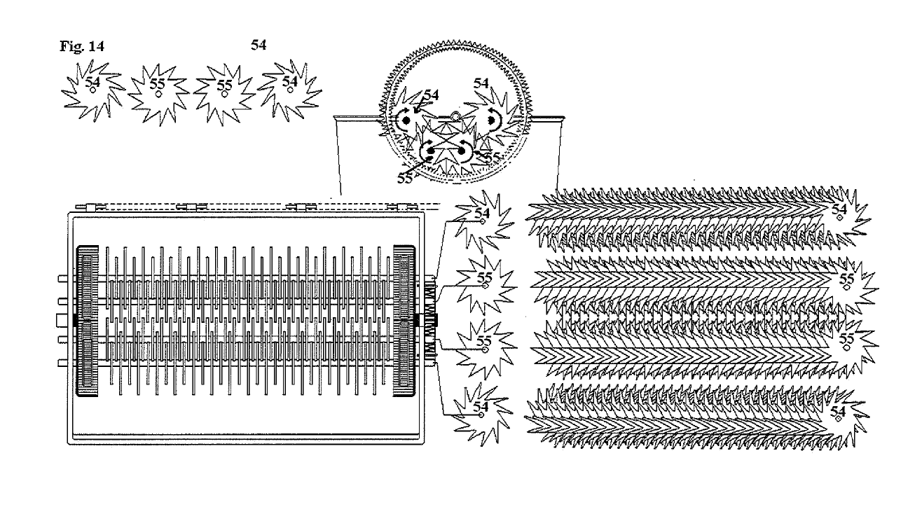

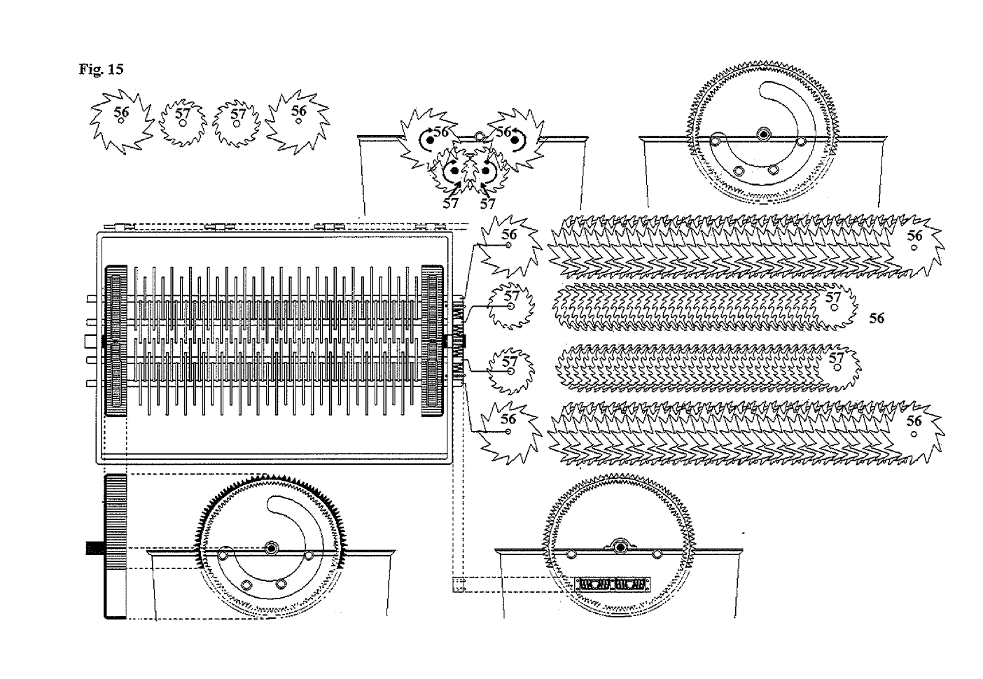

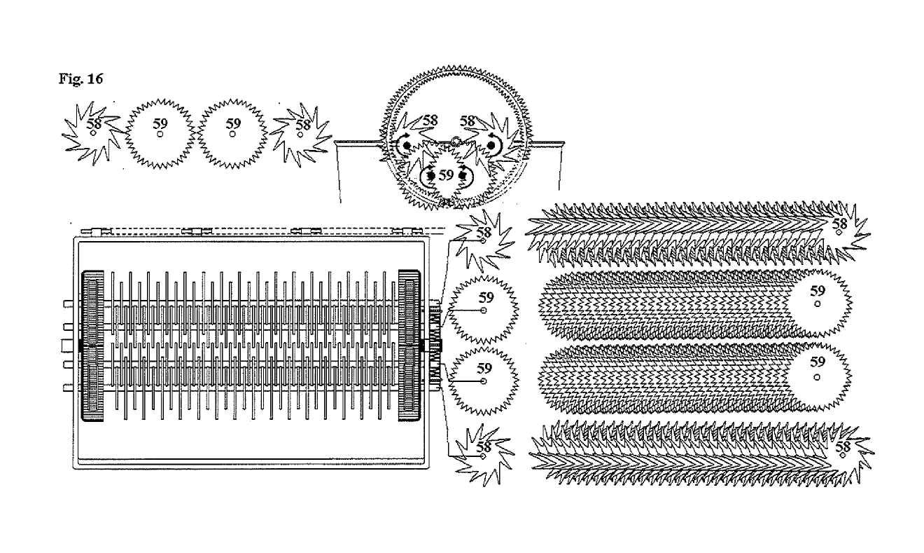

Regarding the design of each type of blade, and in the case of metal containers, its blades are slightly rounded and robust, —which are drawn as an example in FIG. 13 with six teeth or nails in the blades axes (52), and four teeth or nails in the lower blades (53), whereas for the case of plastic containers, its blades incorporate series of sharp teeth or nails, (—as drawn in FIG. 14) with twelve teeth or nails on the blades of the upper axes (54) and twelve teeth in the blades (55) below, and that for the case of cartons, its blades are thinner, having sharp edges and thinner, and are drawn in FIG. 15 with twelve teeth on the upper axes of the blades (56) and sixteen nails (57) below, establishing that in the case of paper and cardboard waste its blades are placed closer to each other, in order to cause a cut torn in the form of small strips, being sufficient that its lower knives have the traditional saw tooth (59), drawn with teeth 40 FIG. 16.

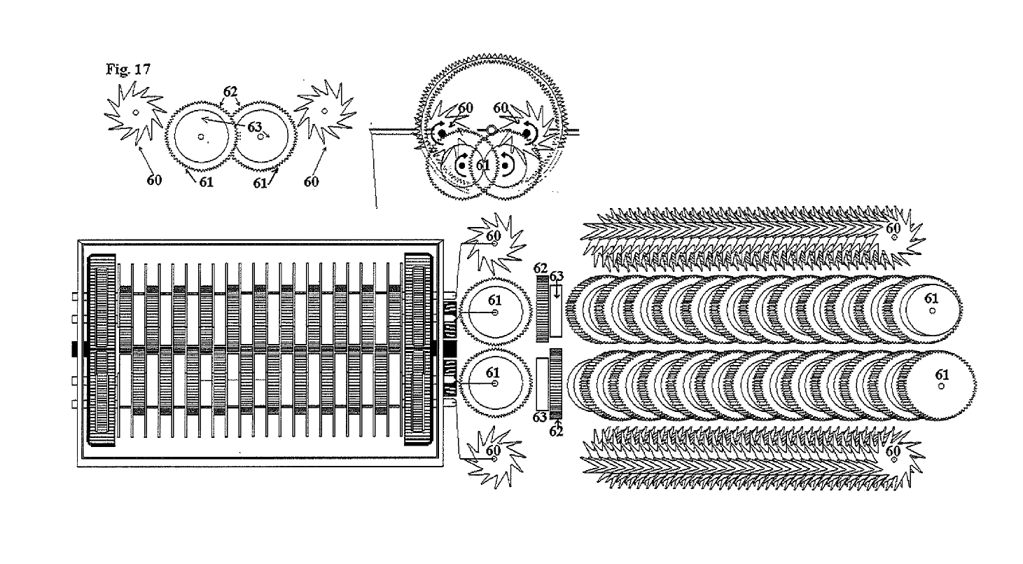

It is also proposed to incorporate blades axes for organic matter (61) with a much wider section of a few centimeters of width, and with the edges of its blades with smaller teeth (62), separating the blades with rubber rollers, which will allow a maximum compression of volume of organic matter, thanks to the higher density of rubber between the blade discs (63) for each axle (—FIG. 17).

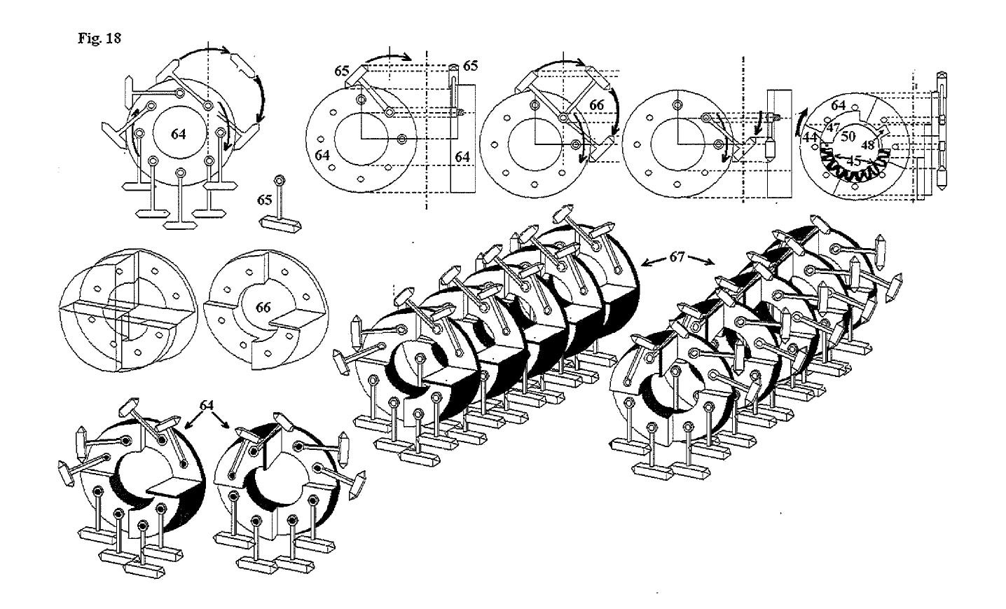

The system proposed for crushing glass is based on a disk set (66) characterized with series of small hammers (65) which are together with its respective disc and articulated arm—in our case and as an example, these articulated arms are plotted in FIG. 18 in the figure number eight (64) so that, having two small hammers of each with four circular sectors that make up each disc a form of a “staircase” (67), produces the beat of the hammer, at all points of the glass breaking in the central zone of the container at least two small hammers on both sides intended for the breakage, which in our case, have two small hammers in each of the four sectors, its operation produces small hammers beating and breaking in each point.

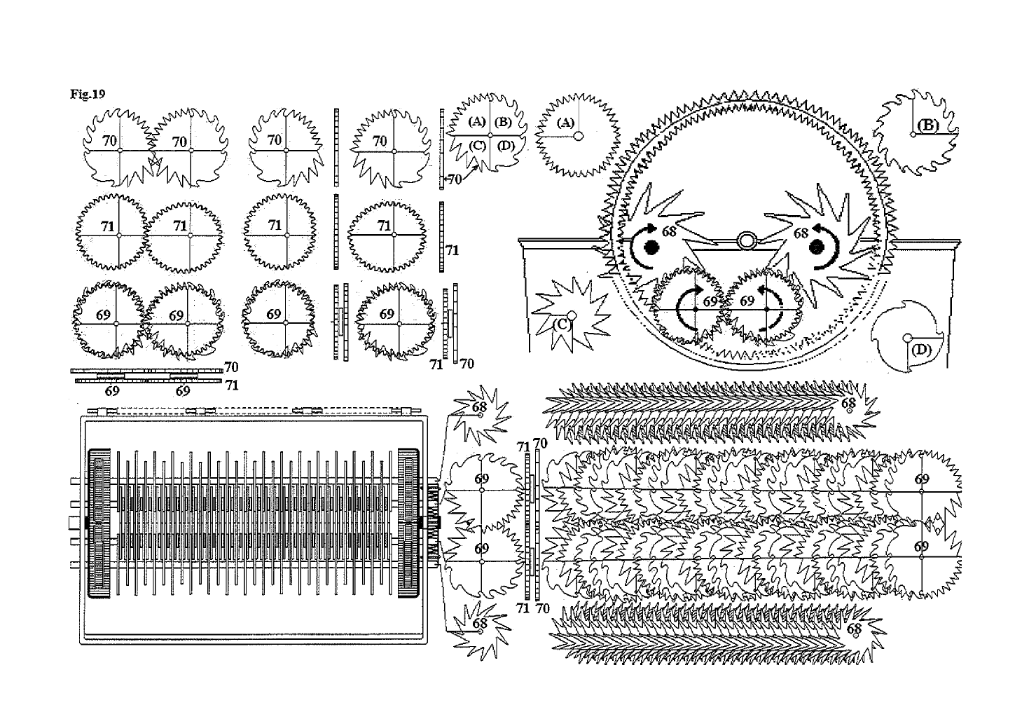

Finally for the collection of non-recyclable waste (FIG. 19) blades (68 and 69) containing a mixture of different types of blades set out above, the type of blades for cans and metal containers—for plastic containers—of cartons, and—paper and cardboard (excluding the type for organic matter and small hammers for glass), combining each of these four types of knife edges, on a rotating basis in each blade sector (70), each blade is inserted in its respective axis alternating position in rotation in a circular movement, therefore four blades followed by a different side) so that its continuous 360 degree turn ensures that waste is grinded in any of the four above mentioned types, with the characteristic double and specific waste grinding such that, in a hand, its blades have a non circular shape, but rather oval—egg-shaped (71), and secondly, that they turn on an “eccentric” pivot point while synchronous with its axis, whose opposite oval blade, will maintain continuous contact with the preceding—despite their identical oval shape, although this second blade also has an eccentric rotation, however is in front of the other blade with a 90 degrees presentation opposite to the first, as shown in FIG. 19.

Another feature of the grinding system is the function of ratchet on each bearing (15) having the blade axes which are embedded in the rack, as (—As a bicycle rear wheel device), this device only allows rotation in a single direction:—the continuous entry of waste, maximizing the container's capacity, not allowing the pawl bearing device the rotation of the opposite blade axis when drums rotate on the opposite side, since such a bearing device only allows rotation in the initial direction, preventing the exit of waste in the opposite direction from the one previously swallowed allowing the filling to its maximum (—changing for each type of waste and by its specific composition in each case—) crushing of the contents slowly and progressively for the simple function of permanent or continuous swallowing allowed by the ratchet device.

Therefore, if a single displacement of the lid is not enough to crush and swallow all waste, we can start over again activating the lid and repeat the operation it is all swallowed.

The only lock limit that is expected by the rotation of the side drums will come from the rise of the frame as a result of up coming caused by the filling of waste to the top of the container, causing the movement of the frame from its initial position, as a result of lifting of the front edge of the frame from its own fixed hinges situated on the bottom side of said frame, and frame whose elevation will prevent the sliding of the lid, which is the origin of the movement of all the system.

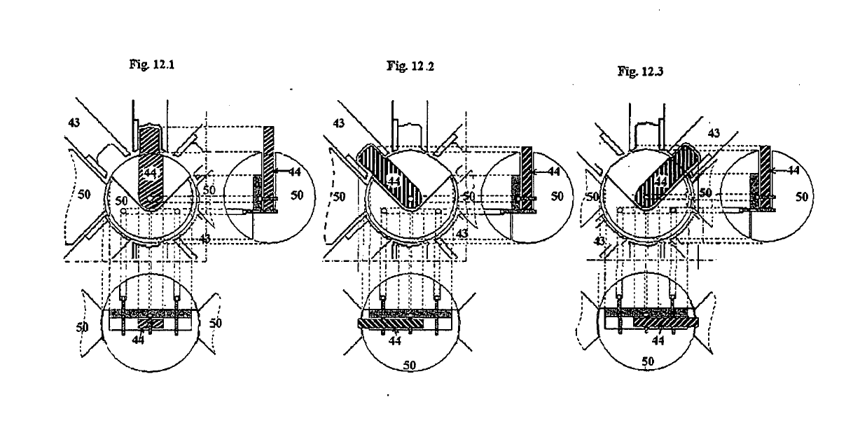

Finally, regarding the problems that may take place by the clogging of the grinding axis as a result of the entry of waste, of a width exceeding the width of entry that the lower shafts tolerates, —in addition to the tolerances that allow previous spring systems already incorporated in the blades themselves, and the twisting system with oblique blades each on its axis, this “tolerant” system, provided in FIG. 21—whose purpose is to win the initial resistance that produce a lower grinding axes fixed on the frame, consisting on placing a system with two “tolerant” springs (72) which are placed at both ends of each axis simultaneously, these two springs placed (76) perpendicular to the direction of the respective shaft in each of the boxes (75) located on both sides of the frame (—as in FIGS. 21.1, 21.2 and 21.3); boxes designed to introduce the lower ends of these axes, and whose only mission is to create an angle that can be opened (77) in order to allow changing the parallelism of both lower blade axes (73) to allow unlocking, as scissors opening-(74) being finally secured the rotation of the ends of the lower axes of the said right drum by the evolving effect of a metallic chain (11)—through its sprockets-R-3 and R-4, inside the drum (—as shown in FIGS. 21.2 and 21.3), despite the fact that toothed wheel R-4 can lose its initial position by in the box, wheel R-4 will necessarily swings due to tension of the smaller sprocket R-6 will exert on chain (25), whose axis tension will make the above mentioned metal chain will be tensioned equally, despite the change in position of wheel R-4.

It will also will produce the lower shaft displacement E-2, by sliding in another box of identical springs housed in the frame, although it may bent in an oblique position and the chain will follow a forced obliquely upward through the end of the said blade axis and put to in permanent contact with the toothed belt of the right drum.

At the same time, for the cleaning of the four blade axes, it is provided the placement of a metal comb to be placed under each axis, with the rotation of each of the tines with respect to its longitudinal axis, so that its spikes can guarantee permanent cleaning and unclog waste that remains caught between the blades, with a fixed frame in case of top axes, though the cleaning of the lower axes have the possibility of having small combs not held to the frame, but with a small fork, attached directly to the lower axis permanently and parallel.

Similarly, in order to expel the waste outside the container, it is provided the placement of a pair of curved hooks opening/closing the lower front edge of the frame, although these hooks are placed to the edge usually on the upper front face of the container the pressure effect of the springs of such hooks can release the pressure that will move the comb due to the truck lifting arm on the triggers on the top of the front face of the body container causing the release of the hooks on the frame.

It also is optionally provided, that can be placed in the bottom of the body of said container with a simple electronic scale (108) with weight indicator, due its small cost, it can be powered either by battery or by a simple rechargeable to be placed at the ends of the blade axes—including the possibility of placing complementary batteries on the axes of the two side drums, having the possibility of placing an electronic weight indicator at the top front face of the container so that, thanks to traditional weight memory systems, may show the weight of waste introduced each time you use the container and transfer to a data center receiving waste weight and notice sent to this center, which will inform you when a container is full, being sufficient to incorporate a SMS system with a simple cell phone, so that, when the frame is raised from the front edge of the cup as a result of overfilling, a continuous signal can be produced in which, by combining this data with weight data entered, can assure that such a signal responds to its actual excessive filling, with the advantage of having information supplied in real time, and knowing at all times when the containers are full, and may design collecting routes through a simple “GPS (107) navigation” program that may arrange cheaper collecting routes.

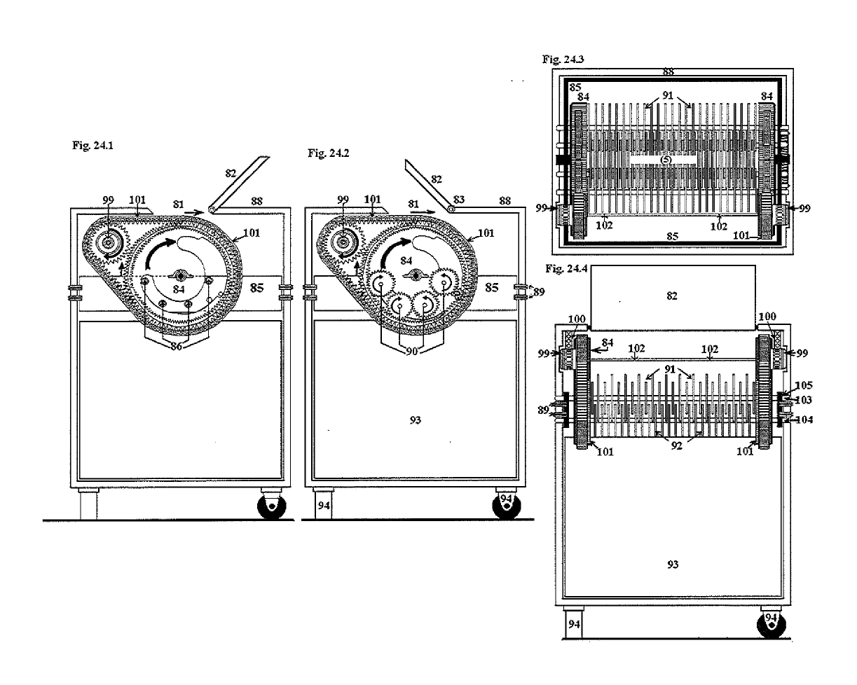

Electrical supply alternative: (—see FIG. 24 —) As a first alternative, although less green, you can change the mechanical origin caused by movement of the upper sliding lid of the container, by placing an electric motor (95) on the frame independent to the body of the container, and can have (98) electrical or an external network supply or a battery (96) incorporated in a portable container, characterized by the electrical motor driving the drums and not from the top lid, in its frame and can be arranged either in a drum side or on both, through a system of gears to ensure the motorized movement of each drum.

An alternative motor position provides the possibility of placing this engine longitudinally in the bottom of the container along the central area of its base, exceeding at both ends of the side walls of the container in its lower central zone, the axes can move each of the drums, both left and right side through a bevel gear shafts, and even by belts or chains pulley sprockets, chains placed independent to the body container, protected under a separate side frame, with an outer cover for opening and for occasional maintenance or mechanical repair. Anticipating further, in the case of belts or chains, the placement on the upper outer side of the container and under the frame, a bearing system to allow passing these belts or chains pulleys from one side of the drum shaft sprocket to another of identical bearings located near the drum axis and parallel to it. In order to allow by this powered bearing change system through an external lever change, the lever can move the pulleys or chain from the bearing rolling parallel drum, and may be release the side drums locking frame linked to the transmission chains, so the frame will get free from its usual position to allow the exit of waste, when not being the lateral drums embedded in its respective chains, being foreseen that for the displacement of the chain by means of a bearings changing system, it is also foreseen a chain stress by providing for an additional wheel with a clamping function, placed along the vertical path of the chain that will grant tolerance.

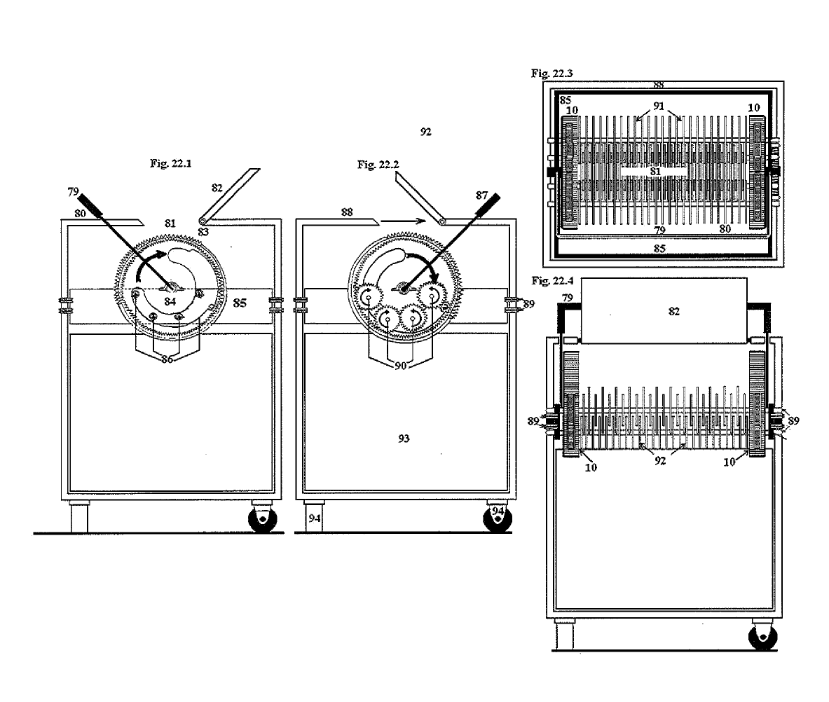

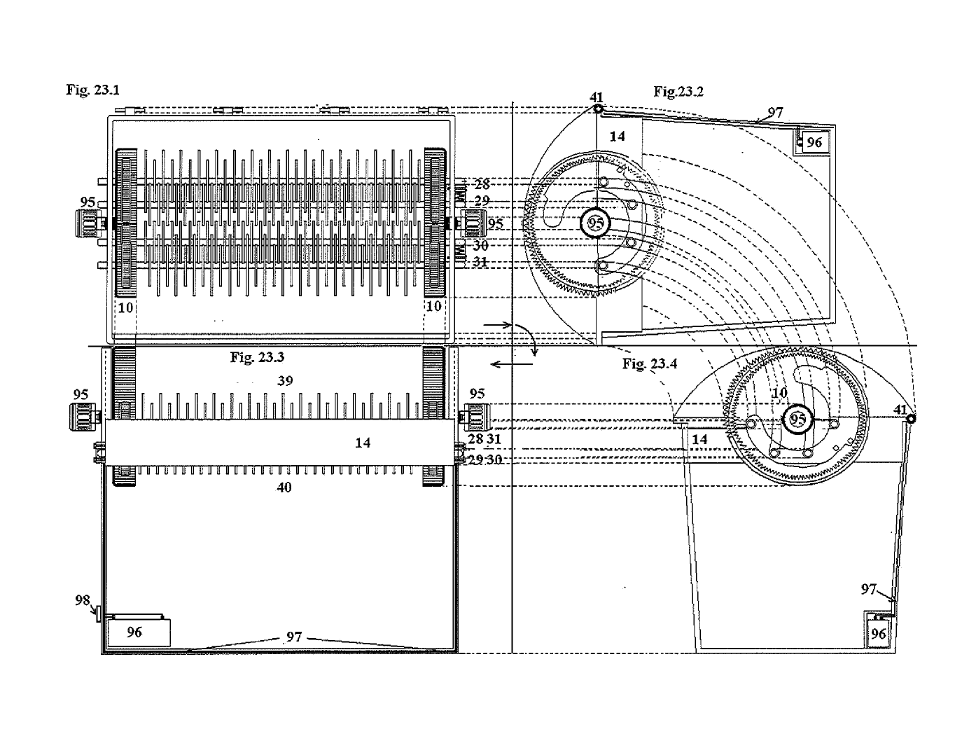

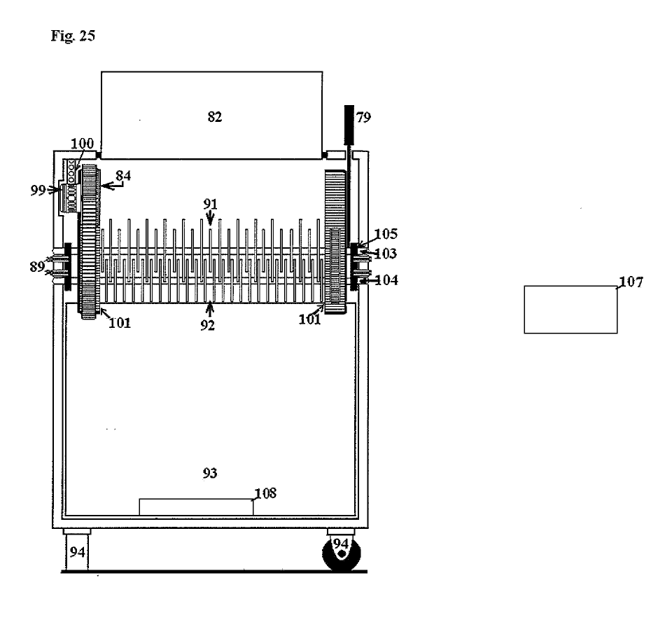

Alternative domestic garbage container: (—see FIGS. 22 and 25.1,): There is another variant planned for domestic garbage container, smaller but identical grinding alternatives, both, manual or electric, but also a mixed system, characterizes this type of domestic garbage container with possible wheels (94) and of a smaller dimension than those designed for public use. It is also possible “fixed” container (smaller size too), put in a cabinet, or placed for example in the kitchen bench (88), or in the balcony, etc. with the possibility to incorporate all types of blades studied in the basic blade system, (—although it seems more appropriate to use the split-blade for non-recyclable waste) incorporating this domestic container all the claims as defined under the basic or general.

In return, the domestic garbage container is remarkable for its safety lid which allows the system to operate only when the crushing is certainly safe, either because when the blades are moving the top lid is closed (—whether it's mechanical or electrical—), or because, when the lid is open, there is a safety guard located between the lid and blades, which allows only the entry of small waste, preventing the possible entry of the user's body limbs. Also provided by an external switch on the top near the entry of the container that allows the user to stop the engine and put it on again to eliminate possible obstructions, or providing a lever for a manual system, which stops the rotation of the blades, thanks to a lever that moves a braking bolt under the R-2 front wheel of the inner toothed belt of the drum, which is what gives motion to both axes lower blades.

Variety developed for the rotation of the grinding blades:

If considered that each operation of opening the lid is not enough for grinding a specific type of waste or is regarded as desirable that each blade axis should realize more than one turn for each lid opening, it is sufficient to introduce a sprocket of double development between the lateral tread which contact the lower supports of both left and right of the lid, with the treads of both drums, so that, the gear which contacts the top, shall move simultaneously a concentric gear, having this last sprocket the double number of teeth (—or triplex, etc.—) which will be responsible for moving the rolling toothed belt of each side drum.

Indication of how the invention is industrially applicable:

Respecting the materials to use to build this grinding container, it is important to say that all parts can be built with common materials, such as plastic for the body container, and different metals for the rest mechanisms of the system (for example steel for blade axes, toothed wheels, drums, or blades, and a strong plastic or hard rubber for some other parts). This material may be satisfactory, and even have the opportunity of using duralumin for the frame (—to endure the pressure on it by the exercise of both side drums and blade axes), which will allow this system to reduce weight of this grinding container. Considering that it does not seem necessary to make this description more extensive for an expert to understand the advantages of this invention, unnecessary to describe the material composition of each part type, shape, size, or arrangement of its elements and not been specified more precisely for reasons of convenience for its patentability, and that may be susceptible to variation not producing an alteration of the invention. So it should be noted that this description has been written, and must be understood in a broad and not limiting sense.

### LISTING OF PARTS

(1) Sliding curved lid.
(2) Swinging protection visor.
(3) Vessel container.
(4) Bar for auxiliary opening.
(5) Handles.
(6) Sliding top axis supported by the glass.
(7) Driving Chain for the lid opening.
(8) Gear box supporting the manual lid opening.
(9) Rolling toothed belts positioned at the bottom of the sliding lid.
(10) Side drums.
(11) Traction chains of the toothed wheels which rotate the blade axes.
(12) Side lever-bar pedal opening.
(13) Toothed skate.
(14) Support frame of side drums and the four blade axes.
(15) Bearing of ratchet to permit rotation of axes E-1, E-2, E-3 and E-4, in an only direction.
(16) Total path of top lid and pedal.
(17) Each lateral drum axis.
(18) Placing of drum on the frame through its axis, showing the position of the four axes guides crossing the drum in a start position.
(19) Placing of the drums on the frame showing the position of the four axes guides crossing the drum in a start position.
(20) R-1 cogwheel rotating of the upper axis E-1.
(21) R-2 cogwheel rotating of the lower axis E-2.
(22) R-3 cogwheel rotating of the upper axis E-3.
(23) R-4 cogwheel rotating of the lower axis E-4.
(24) R-5 minor cogwheel rotating E-3 cogwheel.
(25) R-6 lower toothed wheel provided for tensioning the chain that binds the top axis E-3 and bottom axis E-4 in case of displacement of the axis E-4 of its normal position for the passing of abnormal volume between the lower shafts.
(26) Drums profile, seen from above.
(27) Left drum seen inside indicating the position of the toothed wheels without chains.
(28) E-3 top blade axis.
(29) E-4 lower blade axis.
(30) E-2 lower blade axis
(31) E-1 top blade axis.
(32) Right drum seen from the inside, indicating the position of the toothed wheels with chains.
(33) Drums side profile of the, seen in its raised position (standing)
(34) Blades transversal sight.
(35) Blades axis transversal sight.
(36) Left drum.
(37) Right drum.
(38) Shaft bearings pawl for opening the lid.
(39) Top axes blades.
(40) Lower axes blades.
(41) Hinge's frame on the top edge of the rear side of the body container.
(42) Drum's end.
(43) Common blade.
(44) Lever drag of the blade axis.
(45) Circular spring inside the blade around the shaft passage.
(46) Spring box cover for each blade.
(47) Circular spring box for the blade.
(48) Hollow provided in the blade for the entry of its axis and lever.
(49) Stabilizing springs located between the blades to get the effect of returning blades to their original parallel.
(50) Common blade axes estimating blade position.
(51) Common blade axes indicating internal levers for each blade.
(52) Top blade for the approach of metal containers (canning, packaging, etc.)
(53) Lower blade for the grinding containers or metal containers.
(54) Top blade for the approach of plastic containers.
(55) Lower blade for the grinding of plastic containers.
(56) Top blade for the approach of cartons containers.
(57) Lower blade for grinding of cartons containers.
(58) Top blade for the approach of paper and cardboard.
(59) Lower blade for the grinding of paper and cardboard.
(60) Top blade for the approach of organic matter.
(61) Lower blade for the grinding of organic matter.
(62) Toothed wheels of the blade for the grinding of organic matter.
(63) Rubber rollers of the blade for grinding organic matter.
(64) Blade of small hammers for the crushing of glass.
(65) Small glass crushing hammers.
(66) Disks of small glass grinding hammers.
(67) Composition of crushed glass disks “in series”, and its presentation with opposite composition as “reflection” or “mirror”.
(68) Top blade for the approach of non-recyclable waste (Unusable—)
(69) Bottom double blade for crushing of non-recyclable waste.
(70) Sheet of double cutting blade for the crushing non-recyclable waste.
(71) Eccentric leaf of double blade for the non-recyclable waste giving a cut a winding effect.
(72) Tolerance devices.
(73) Axis E-3 and E-4 in stable position on the frame.
(74) Axis E-3 and E-4 in a forced position on the frame.
(75) Box for axis, springs and tolerance devices.
(76) Tolerance springs and stabilizing the axis of the tolerance device.
(77) Width of tolerance.
(78) Background Wheel.
(79) Bar of domestic garbage container.
(80) Path of the lever of domestic garbage container.
(81) Top entry of domestic garbage container.
(82) Top cover for the entry of household garbage container.
(83) Hinge of top cover
(84) Side drums of domestic container.
(85) Frame of domestic garbage container.
(86) Bearings for blade axis of domestic garbage container
(87) Final path of lever for domestic garbage container.
(88) Cabinet covering the domestic garbage container.
(89) Frame screw of the domestic container.
(90) Toothed wheels responsible of moving the blade axis in its bearings.
(91) Top axis blades.
(92) Lower axis blades.
(93) Box of crushed waste.
(94) Leg/wheel.
(95) Electric motor of the crushing container.
(96) Battery.
(97) Wiring from battery to motors.
(98) External power source for alternative power.
(99) Electric motor of domestic container.
(100) Engine bracket.
(101) Transmission chain.
(102) Driving Axle
(103) Top axes blades.
(104) Lower blade axes.
(107) GPS
(108) Scale

1. A crushing container for solid waste collection, said crushing container comprising:
a container body, said container body defining an upper aperture leading thereinto, said upper aperture being delimited by a frame;
first and second crushing elements each supported in said container body and rotatable respectively about a first and a second crushing element axis extending generally parallel to said upper aperture, said first and second crushing elements including respectively a first and a second plurality of grinding blades extending generally substantially perpendicular respectively to said first and second crushing element axes, said grinding blades of said first crushing element being interleaved with said grinding blades of said second crushing element, said first and second crushing elements being operatively coupled to each other so as to be jointly counter-rotatable with respect to each other; and
a sliding lid provided substantially adjacent said upper aperture, said sliding lid being slidably movable relative to said container along said upper aperture so as to be positionable in a lid closed position, wherein said sliding lid is substantially in register with said upper aperture, and a lid open position wherein said sliding lid is at least partially retracted from said upper aperture, said sliding lid being operatively coupled to said first and second crushing elements for rotating said first and second crushing elements about said first and second crushing element axes when said sliding lid is moved between said lid open and closed position.

2. The crushing container of claim 1, wherein said first and second crushing elements include respectively a first axle and a second axle, said first and second axles being parallel respectively relative to said first and second crushing element axes, said first and second plurality of grinding blades being mounted respectively to said first and second axles.

3. The crushing container of claim 2, further comprising:
a set of gears operatively connecting said first and second axles for counter-rotating said first and second plurality of grinding blades with respect to each other when any one of said of said first and second crushing elements is rotated; and
a gear driving element operatively coupled to said set of gears to effectuate rotation of said first and second plurality of grinding blades.

4. The crushing container of claim 3, wherein said set of gears comprises at least one of the group: epicyclical, cycloidal, and planetary.

5. The crushing container of claim 3, wherein said gear driving element is chosen from the group: manual, hand-operated and foot operated.

6. The crushing container of claim 3, wherein said set of gears is chain driven.

7. The crushing container of claim 2, wherein said first and second axles and said first and second plurality of grinding blades are spring loaded.

8. The crushing container of claim 2, further comprising a ratcheting system for preventing retrograde movement of said first and second pluralities of grinding blades.

9. The crushing container of claim 2, wherein said first and second plurality of grinding blades are respectively pivotable with respect to said first and second axles to change a respective blade-to-axle angle therebetween.

10. The crushing container of claim 1, further comprising a scale for weighing ground waste material.

11. The crushing container of claim 1, wherein said crushing container is operable to communicate with a global positioning system (GPS) for signaling location of ground waste material.

12. The crushing container of claim 2, wherein:
said sliding lid defines at least one toothed band extending substantially parallel to a direction of motion of said sliding lid as said sliding lid moves between said lid open and closed positions;
said crushing container further comprises a toothed drum rotatable about a drum axis, said drum axis being substantially parallel to said first and second crushing element axes, said toothed drum engaging said toothed band such that moving said lid between said lid open and closed positions rotated said toothed drum about said drum axis; and
said first and second crushing elements are operatively coupled to said toothed drum such that a rotation of said toothed drum about said drum axis rotates said first and second crushing elements about said first and second crushing element axes.

13. The crushing container of claim 12, wherein said toothed drum defines outer teeth facing outwardly and engaging said toothed band.

14. The crushing container of claim 13, wherein said toothed drum is hollow and defines inner teeth facing inwardly, at least one of said first and second crushing elements including a toothed gear engaging said inner teeth.

15. The crushing container of claim 14, wherein said toothed drum and said first and second crushing elements are mounted to said frame.
